(19) United States
(12) Patent Application Publication
(10) Pub. No.: US 2024/0388017 A1
(43) Pub. Date: Nov. 21, 2024

(54) Tap Clamp Handwheel Drive

(71) Applicant: Greg Nolan YOUNG, Eureka, CA (US)

(72) Inventor: Greg Nolan YOUNG, Eureka, CA (US)

(21) Appl. No.: 18/318,469

(22) Filed: May 16, 2023

(51) Int. Cl. H01R 11/15; H02G 1/02

(52) U.S. Cl. CPC H01R 11/15; H02G 1/02

(57) ABSTRACT

A tap clamp handwheel drive installs to an existing tap clamp bolt head. In one embodiment, the tap clamp handwheel drive installs to a bolt head. In another, the tap clamp handwheel drive installs to a hot stick loop. In another embodiment, the tap clamp bolt is forged or manufactured with a handwheel drive installed thereto. The tap clamp handwheel drive increases the outer diameter of the tap clamp bolt head enabling increased prehensility for line men operating in glove mode. Additionally, insulating, non-conductive materials may render the tap clamp lighter and provide additional insulating, non-conductive materials between the lineman and the conductor with which the tap clamp is applied.

### CROSS-REFERENCE TO RELATED APPLICATIONS

Not Applicable

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

Tap clamps, or hot line clamps as they are also known in the art, are used by linemen to manipulate conductors when installing or repairing or otherwise servicing utility lines. Typically, a gate or clamp is secured to a portion of a conductor, whether energized or not, by action of a threaded bolt member rotationally engaging the jaws of the clamp between an open or a closed position. The threaded bolt member typically includes a hot stick loop, a circular ring disposed endwise at the proximal or exposed end of the bolt member. The hot stick loop is devised for engagement by nonconducting rods (so called “hot sticks”) whereby the threaded bolt member may be engaged to open and close the clamp upon energized conductors while insulating the lineman during contact with the tap clamp.

Modernly, linemen also operate in “glove mode.” Glove mode refers to operations by linemen clad in heavy, insulated gloves, worn to protect the linemen from inadvertent contact with live conductors while servicing electric transmission lines and other charged or energized conductors. Glove mode may render use of a hot stick unnecessary since the insulated gloves may serve to protect grounding through contact with live conductors by the hands. However, manual engagement of the threaded bolt member on tap clamps seen in the art is often confounded by the gloves when a lineman is operating in glove mode because the exposed end of the threaded bolt member is difficult to grasp with the heavy, thickset gloves. Linemen typically compensate by using both hands to twist the bolt member awkwardly to engage the clamp between the open and closed positions. Or they may remove the gloves. This presents disadvantages in wasted time and from the need to keep both hands on the bolt member. Removing the gloves can increase risk of electrocution.

What is needed is a tap clamp handwheel drive that is installable to a tap clamp, or usable in place of the standard tap clamp blot seen in the art, which presents an enlarged outer diameter for engagement by a gloved hand whereby a lineman can operate the tap clamp singlehandedly, or with more ease and facility than without the handwheel drive. Additionally, the handwheel drive may include insulating and nonconducting materials to further insulate the lineman from potential harm in touching tap clamps engaged to live conductors.

### FIELD OF THE INVENTION

The present invention relates to a tap clamp drive devised to assist linemen in operating tap clamps engaged to energized conductors, especially in glove mode. The present invention further enables addition of a hot stick loop to tap clamp bolts that May not have hot stick loops integrated therewith. The present invention further contemplates lighter materials and may present additional insulated and nonconductive layers between the lineman and the conductor to which the tap clamp is applied.

### SUMMARY OF THE INVENTION

The present tap clamp handwheel drive has been devised to enable easier manual engagement of a tap clamp especially by a lineman operating in glove mode. The present tap clamp handwheel drive presents several embodiments devised to attach to the exposed ends of various threaded bolt members seen in the art and, in an alternative embodiment, to replace the threaded bolt member outright.

As used herein throughout, the term “handwheel” means a rotatable body that presents an enlarged outer diameter (or transverse dimension) relative to the diameter of a threaded member or threaded bolt member to which or upon which the handwheel is disposed. As such, the handwheel increases facility in manually operating the tap clamp by presenting an enlarged circumference and a greater area to increase prehensility of a lineman manipulating the tap clamp, especially when operating in glove mode, such as when manning utility lines or other energized conductors while wearing insulating, nonconductive gloves as a safety precaution. The enlarged outer diameter or transverse dimension may also include tractive elements, such as ridges, angled surfaces, or other frictional structures or features to increase traction when manually manipulated, particularly by linemen operating in glove mode.

In an example embodiment contemplated herein, the tap clamp handwheel drive includes a threaded member disposed with an engagement end operatively couplable to the tap clamp whereby rotation of the threaded member effectuates movement of the tap clamp between an open position and a closed position. A handwheel is disposed upon the threaded member at, or proximal to, the terminus of an exposed end of the threaded member. In some embodiments, a hot stick loop may be disposed endwise upon the handwheel. It is contemplated that the tap clamp handwheel drive may be manufactured of nonconductive, insulating materials, such as, for example, glass, ceramic, PA6 nylon, or other polymers or substances insulative and nonconductive of electrical energy.

In another embodiment contemplated herein, the tap clamp handwheel drive may be attachable to an existing threaded bolt member already installed to a tap clamp. In this example embodiment, the tap clamp handwheel drive is configured to secure to the threaded bolt head whereby a handwheel member accommodates the bolt head to present an enlarged outer diameter and increased area for manual engagement. A hot stick loop may likewise be disposed endwise upon the handwheel drive, or engaged interior to the handwheel drive, as will be described subsequently. In an example embodiment set forth herein, the handwheel drive includes a first portion and a second portion. The first portion is connectable around at least a portion of the bolt head and the second portion is connectable around the remaining portion of the bolt head. In this embodiment, the bolt head may be accommodated in a seat disposed in the interior surface of each of the said first and second portions. In one embodiment, the seat is configured to accommodate a bolt head having wrench flats disposed thereabouts. In another embodiment, the seat is configured to accommodate the bolt head disposed in the form of a hot stick loop, as is commonly seen in the art.

A handwheel drive is disposed proximal an exposed end to present an increased outer diameter for manual engagement to operate the tap clamp.

Thus has been broadly outlined the more important features of the present tap clamp adaptor so that the detailed description thereof that follows may be better understood and in order that the present contribution to the art may be better appreciated.

Objects of the present tap clamp adaptor, along with various novel features that characterize the invention are particularly pointed out in the claims forming a part of this disclosure. For better understanding of the tap clamp adaptor, its operating advantages and specific objects attained by its uses, refer to the accompanying drawings and description.

### BRIEF DESCRIPTION OF THE DRAWINGS FIGURES

FIG. 1 is a raised elevation view of a prior art tap clamp.

FIG. 2 is an exploded view of an example embodiment of the present invention installable to a bolt head of clamp bolt.

FIG. 3 is a raised elevation view of as example embodiment installed to a bolt head of a bolt clamp.

FIG. 4 is an exploded of an example embodiment devised for installation to a bolt head.

FIG. 5 is an exploded view of an example embodiment devised for installation to a bolt head wherein the bolt head includes a hot stick loop.

FIGS. 6a through 6e depict a raised elevation views of a plurality of example embodiments installed to a variety of existing tap clamps and/or clamp bolts.

### DETAILED DESCRIPTION OF THE DRAWINGS

The present tap clamp handwheel drive has been devised, in multiple example embodiments, to install to existing tap clamps currently seen in the art. In another example embodiment, a tap clamp handwheel drive is contemplated that replaces the threaded clamp bolt used to open and close the clamp jaws. Thus, example embodiments are contemplated that replace the threaded clamp bolt seen in the art, in addition to example embodiments that are devised to directly attach to the bolt head of a tap clamp bolt extant in-use of tap clamp bolts seen in the art today.

It should be noted by persons skilled in the art that the present example embodiments set forth herein are provided to illustrate the general concept by which the present tap clamp handwheel drive is contemplated to operate. These figures should not be considered limiting embodiments in and of themselves. Particular attention should be given to the claims, which alone define requisite scope of the inventive step the accompanying figures enumerate as examples reduced in practice. The structures shown in the accompanying figures, therefore, are exemplary only. Therefore, equivalent structures are contemplated as in scope of this disclosure where operating in substantially the same way to accomplish substantially the same result. Thus, additional embodiments not shown herein are contemplated as within the scope of this disclosure, the present embodiments providing examples only by which the accompany claims May be more readily understood.

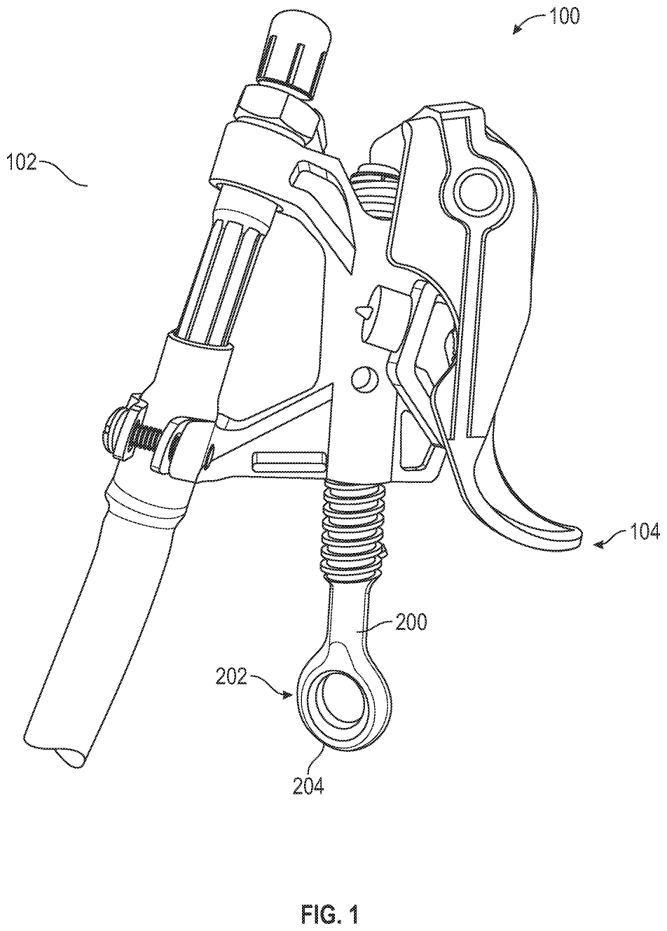

Turning now to the figures, FIG. 1 illustrates an elevation view of an example of the prior art. Tap clamp 100 is wielded endwise aloft insulated staff 102 to engage with conductors (not shown) such as utility cables. Tap clamp bolt 200 is rotatably disposed to move clamp jaws 104 between an open and closed position, or to secure tap clamp 100 to a conductor (not shown). Tap clamp bolt 200 includes bolt head 202, which is here shown including hot stick loop 204. Hot stick loop 204 is devised for engagement with an insulated, non-conducting hot stick (not shown), whereby a lineman may distally effectuate rotation of tap clamp bolt 200 to open and close tap clamp 100. Thus, the instant tap clamp 100 is usable to engage with energized conductors.

As mentioned above, presently linemen typically operate in glove mode. That is, they interact with conductors while wearing thick, heavyset insulating gloves (not shown) to protect them from inadvertent contact with live conductors. Due to the required insulating capacity of such gloves when operating on or near high-voltage transmission lines and similar high-power conductors, insulating gloves used in glove mode are necessarily thick and unwieldy. Thus, wielding of a hot stick—as well as attempted manual engagement of hot stick loop 204 at tap clamp bolt head 202—is hampered in glove mode. The present invention increases prehensility of linemen wearing gloves by presenting a handwheel drive 10 having an increased outer diameter 80 for manual engagement therewith, potentially augmented with tractive features 82, whereby manual manipulation of the tap clamp may be effectuated manually and single-handedly.

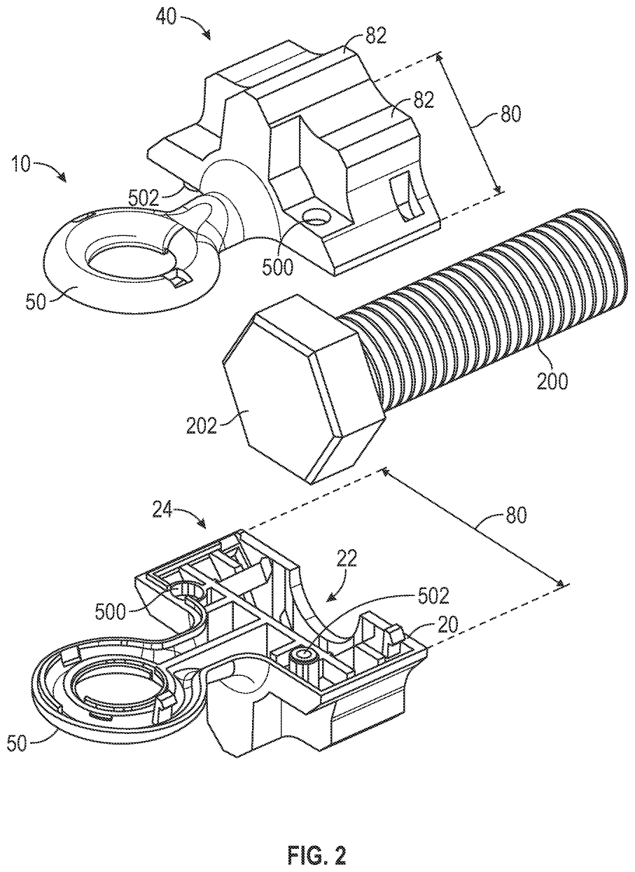

Turning now to an example embodiment of the tap clamp handwheel drive 10, FIG. 2 illustrates an exploded view of an example embodiment of the instant tap clamp handwheel drive 10. In this example embodiment, handwheel drive 10 is securable to bolt head 202 of tap clamp bolt 200 by engagement of first portion 20 to second portion 40 encompassing bolt head 202 therebetween.

First portion 20 is connectable around one side of bolt head 202. First portion 20 includes first seat 22 in interior surface 24, wherein at least a portion of bolt head 202 is configured to nest. Second portion 40 likewise includes a second seat 42 in interior surface 44 configured to securely accommodate the remaining portion of bolt head 202 therein when first and second portions 20, 40 are conjoined with interior surfaces 24, 44 in contact. In the example embodiment shown, first portion 20 is securable to second portion 40 by action of at least a pair of threaded fasteners (not shown) securably insertible through apertures 500 to engage within sinks 502.

In this example embodiment, handwheel drive 10 includes a hot stick loop 50 disposed endwise thereupon whereby the tap clamp bolt head 202 may be augmented with hot stick loop 50 such that the tap clamp 100 may be operable by a hot stick when deployed to a conductor.

Tap clamp handwheel drive 10 may be rendered of nonconducting materials to add additional insulated, nonconducting layers between the lineman and a conductor to which the clamp 100 is attached. Materials may include fiberglass, glass, ceramic, plastics, non-conductive polymers, aramids, nylons, silicones, rubberlike compounds, other non-conducting insulating compounds or materials, or any combination thereof.

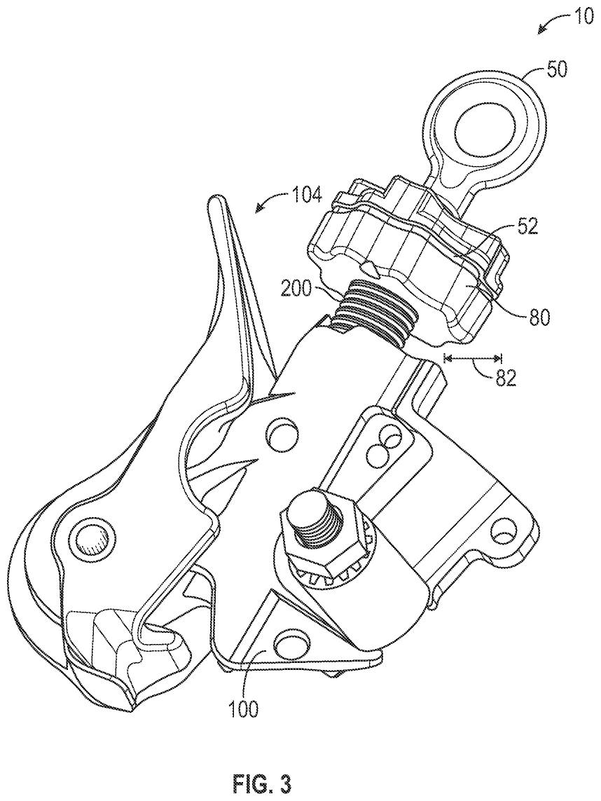

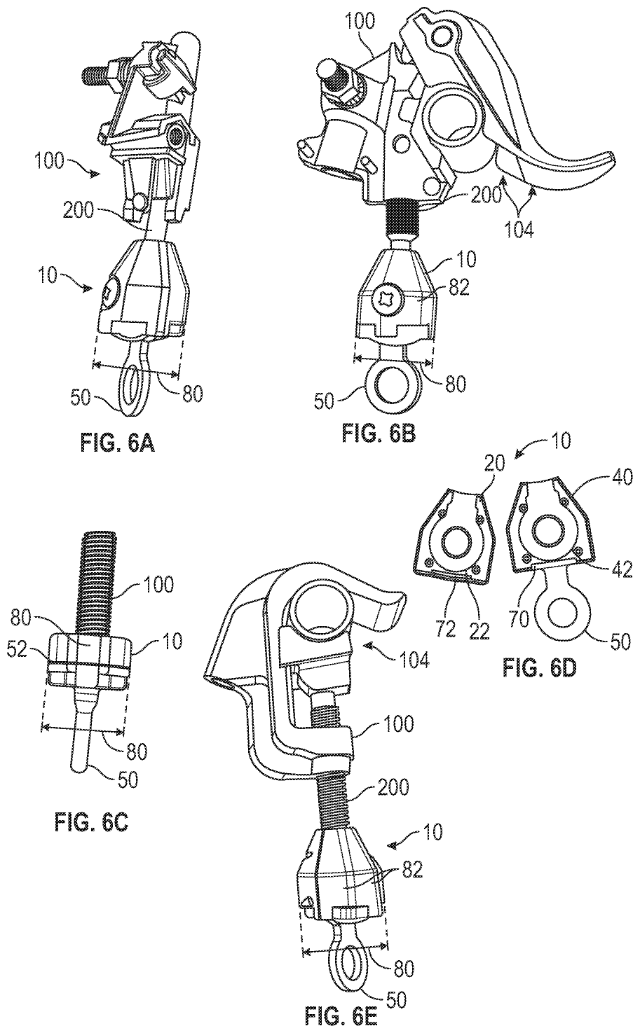

It should be noted that other and additional means of securing handwheel drive 10 to bolt head 202 are contemplated as within scope of this disclosure including, for example, an embodiment wherein hot stick loop 50 is securable endwise onto handwheel drive 10. See, e.g., FIGS. 3 and 6c.

FIG. 3 illustrates an example embodiment secured to tap clamp bolt head 202. In this embodiment, hot stick loop 50 may be attachable endwise onto handwheel drive 10 at join 52. Otherwise, the example embodiment shown in FIG. 3 is substantially similar to the embodiment depicted in FIG. 2. First portion 20 encapsulates at least a portion of bolt head 202 while second portion 40 encapsulates the remaining portion of bolt head 202. First and second portions 20, 40 are secured together encompassing bolt head 202 in each respective seat 22, 42 devised to accommodate the respective portion of bolt head 202 therein.

Hot stick loop 50 may also comprise portions devised for attachment to each of the first and second portions 20, 40. Alternatively, hot stick loop 50 may be integrated with handwheel drive 10, or with the first portion 20 or alternatively the second portion 40. See, e.g., an embodiment shown in FIG. 6d.

In this example embodiment, tap clamp handwheel drive 10 is contemplated to be manufactured from fiberglass reinforced plastic injection molded parts. Composite manufacture may increase the strength of hot stick loop 50, for example, create more lightweight, insulated, nonconducting parts able to interact with high voltage transmission lines and other high-powered conductors, and presents nonconductive, insulated materials for interaction with and manipulation by a lineman. As shown, handwheel drive 10 presents an increased outer diameter 80 whereby a gloved lineman, operating in glove mode, may more easily turn tap clamp bolt 200 manually without having to use both hands. Tractive elements 82 may increase facility in operation in glove mode.

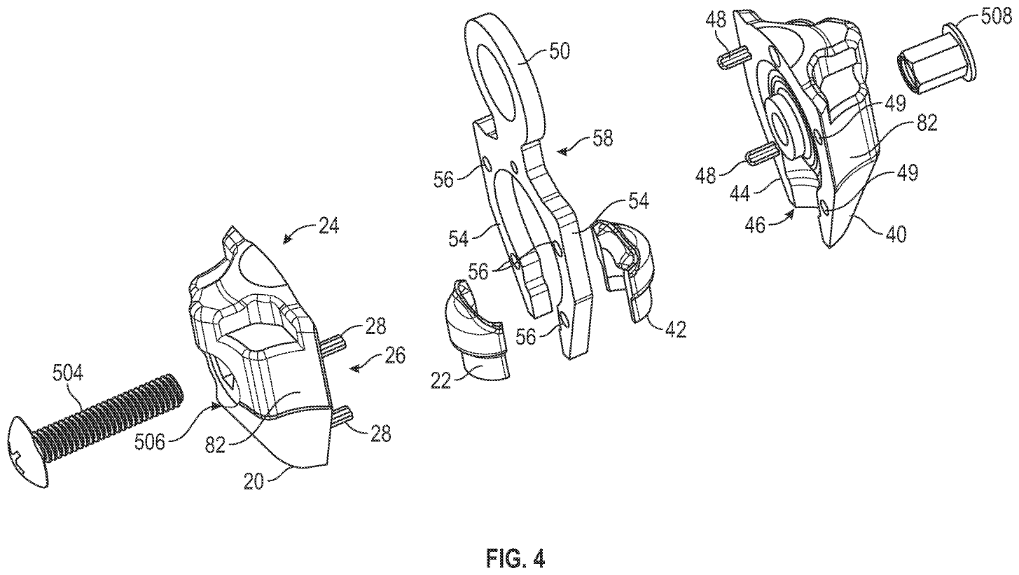

FIG. 4 illustrates an exploded view of an example embodiment in alternative to the example embodiments shown in FIGS. 2 and 3. In this embodiment, hot stick loop 50 is securably fastened in between first portion 20 and second portion 40 of handwheel drive 10 on either side of tap clamp bolt head (not shown), which is engaged in first and second seats 22, 42.

In this example embodiment, a wide truss bolt 504 secures tap clamp handwheel drive 10 to the tap clamp bolt head 202 though aperture 506 engaged by heavy duty rivet nut 508. First and second seats 22, 42 are molded and are engaged by handwheel drive 10 in corresponding first and second seat pockets 26, 46. Handwheel drive 10 first and second portions 20, 40 are stabilized in contact by action of projection members 28, 48 configured to penetrate and engage interior to corresponding apertures 29, 49 disposed on corresponding portions of opposing interior surfaces 24, 44.

In this example embodiment, hot stick loop 50 may be manufactured, molded, cast, or laser or waterjet cut, from aluminum, or other metal or material suited for the purpose. In this example embodiment, hot stick loop 50 includes tine members 54 disposed to superimpose upon interior surfaces 24, 44 of first and second portions 20, 40 to match the contour of handwheel drive 10 when first and second portions 20, 40 are conjoined and secured together. Projection members 28, 48 may penetrate hot stick loop 50 tine members 54 through apertures 56 to secure hot stick loop 50 in position. Additional fasteners may be employed (aperture 58 on upper portion of hot stick loop tines is herein represented as example). In this embodiment, therefore, hot stick loop 50 may be included or omitted, as desired, when handwheel drive 10 is installed to an existing tap clamp bolt head 202.

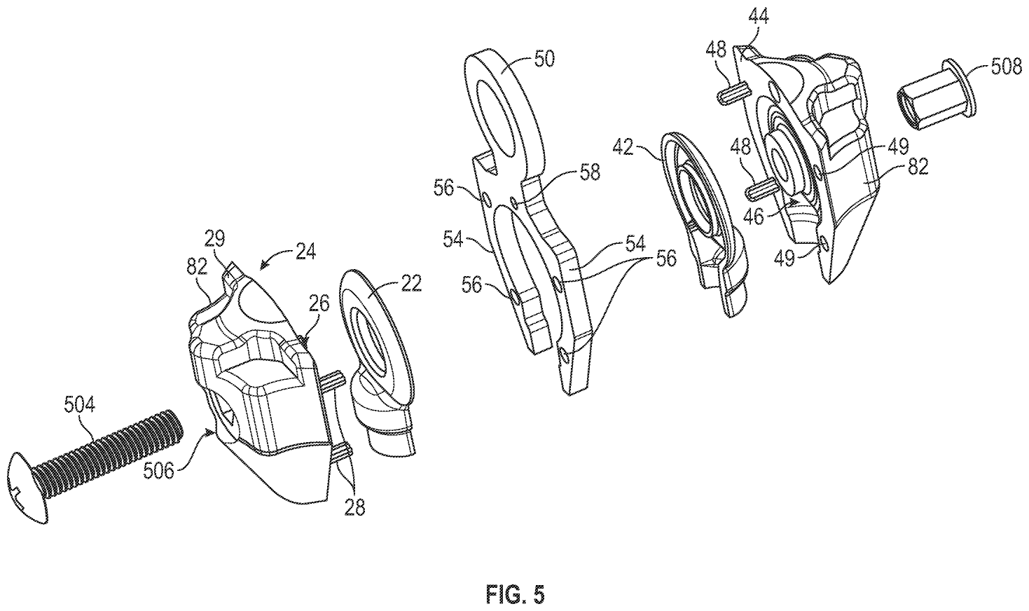

FIG. 5 illustrates an exploded view of an example embodiment similar to the example embodiment shown in FIG. 4 but having first and second seats 22, 42 configured to accommodate a tap clamp bolt head 202 having an existing hot stick loop 204 disposed thereupon. Thus, in this example embodiment, first seat 22 is configured to house at least a portion of an extant hot stick loop (not shown) therein, and second seat 42 is configured to house the remaining portion thereof. First seat 22 is devised to secure interior to first seat pocket 26 disposed in interior surface 24 of first portion 20, and second seat 42 is devised to seat interior to second seat pocket 46 disposed in interior surface 44. Hot stick loop 50 is configured as shown in FIG. 4.

By enabling fungible first and second seats 22, 42 (to accommodate a bolt head 202 as exemplified in FIG. 4 versus a hot stick loop 204 as exemplified in FIG. 5) less individualized parts need be manufactured to accommodate the plurality of tap clamps 100 and tap clamp bolts 200 extant on the market today. Different first and second a seats 20, 40 are contemplated which may be made to accommodate different bolt head shapes, too, for example (the example embodiment herein shown includes a hex head, for example, as well as a hot stick loop, however other and additional bolt head shapes are contemplated as within scope of this disclosure).

FIGS. 6a through 6e illustrate a plurality of example embodiments installed to a variety of tap claims 100 seen in the art. These examples are not exhaustive, but representative. For example, FIG. 6a depicts the embodiment exemplified in FIG. 4 installed to the tap clamp 100. Hot stick loop 50 tine member 54 is visible along contour of handwheel drive 10. FIG. 6b depicts the embodiment exemplified in FIG. 5. FIG. 6c depicts the embodiment exemplified in FIG. 3 attached to a tap clamp bolt, for later insertion into a tap clamp 100. In this embodiment, hot stick loop 50 may be removably secured to handwheel drive 10. FIG. 6d illustrates an alternative example embodiment of a handwheel drive 10 installable to a tap clamp bolt head 202 having a hot stick loop 204 there attached. In this example embodiment, first portion 20 includes hot stick loop seat 22 and second portion 40 includes hot stick loop seat 42 disposed in interior surfaces 24, 44 thereof (i.e., there is no seat pockets 26, 46 in this embodiment) whereby first and second portions 20, 40 connect together and house bolt head 202 directly in seats 22, 42 irremovably formed into the interior surfaces 24, 44 thereof. Four fasteners in this example embodiment secure the first and second portions 20, 40 together. Hot stick loop 50 is disposed upon second portion 40 only, and flanged engagement member 70 is disposed to seat into receiving slot 72 disposed on first portion 20. FIG. 6e depicts an alternative embodiment of the embodiment exemplified in FIG. 2.

It is further contemplated that tap clamp bolts 200 may be forged with handwheel drives 10 formed thereupon at time of manufacture. In such embodiments, handwheel drive 10 is not attachable to the bolt head 202, but is integrally, irremovably formed therewith. Such tap clamp bolts 200, then, include handwheel drive 10 integrally formed at or proximal to the bolt head 202 whereby a threaded section is usable to control action of the tap clamp 100 to which the bolt 200 is installed. Such embodiments may resemble, for example, the embodiment shown in FIG. 6c, wherein hot stick loop 50 may be attachable to the terminus of the handwheel drive as desired.

What is claimed is:

1. In a tap clamp for use with line conductors, a tap clamp handwheel drive comprising:
a threaded member having:
an engagement end disposed operationally coupled with the tap clamp, said engagement end engaging the tap clamp between an open position and a closed position when the threaded member is rotated in each of a corresponding first direction and a second direction;
an exposed end distally oriented relative to the tap clamp; and
a handwheel disposed upon the threaded member more proximal the exposed end;
wherein the handwheel presents an enlarged outer diameter proximal the exposed end whereby a user can more easily engage the tap clamp between the open position and the closed position by manual engagement with the handwheel, especially when operating in glove mode.

2. The tap clamp handwheel drive of claim 1 further comprising a hot stick loop disposed endwise upon the threaded member at the exposed end.

3. The tap clamp handwheel drive of claim 1 further comprising nonconductive material whereby the tap clamp handwheel drive insulates contact when the tap clamp is engaged with energized conductors.

4. The tap clamp handwheel drive of claim 2 further comprising nonconductive material whereby the tap clamp handwheel drive insulates contact when the tap clamp is engaged with energized conductors.

5. In a tap clamp for use with line conductors, a tap clamp handwheel drive devised for securement to an existing tap clamp bolt, said tap clamp handwheel drive comprising:
a handwheel member configured to secure around a tap clamp bolt head disposed endwise upon the tap clamp bolt, said handwheel member comprising:
a first portion connectable to one side of the tap clamp bolt head;
a second portion connectable to the other side of the tap clamp bolt head;
a first seat disposed upon an interior surface of the first portion, said first seat configured to house at least a portion of the tap clamp bolt head therein; and
a second seat disposed upon an interior surface of the second portion, said second seat configured to house at least the remaining portion of the tap clamp bolt head therein;
wherein the handwheel member is securable to the tap clamp bolt when the tap clamp bolt head is encased in the first and second seats and the first portion is secured to the second portion.

6. The tap clamp handwheel drive of claim 5 wherein the tap clamp bolt head is a hot stick loop.

7. The tap clamp handwheel drive of claim 5 further comprising a hot stick loop disposed distally projected endwise from handwheel member.

8. The tap clamp handwheel drive of claim 7 wherein the hot stick loop is disposed upon the second portion.

9. The tap clamp handwheel drive of claim 8 wherein the hot stick loop includes an engagement member disposed to engage into the first portion when the handwheel member is installed to a tap clamp bolt.

10. The tap clamp handwheel drive of claim 5 further comprising nonconductive material whereby the tap clamp handwheel drive insulates contact when the tap clamp is engaged with energized conductors.

11. The tap clamp handwheel drive of claim 9 further comprising nonconductive material whereby the tap clamp handwheel drive insulates contact when the tap clamp is engaged with energized conductors.

12. The tap clamp handwheel drive of claim 5 further comprising a hot stick loop connectable thereto.

13. In a tap clamp for use with line conductors, a tap clamp handwheel drive devised for securement to an existing tap clamp bolt, said tap clamp handwheel drive comprising:
a handwheel member configured to secure around a tap clamp bolt head disposed endwise upon the tap clamp bolt, said handwheel member comprising:
a first portion connectable to one side of the tap clamp bolt head;
a second portion connectable to the other side of the tap clamp bolt head;
a first seat pocket disposed upon an interior surface of the first portion, said first seat configured to house a first seat therein;
a second seat pocket disposed upon an interior surface of the second portion, said second seat pocket configured to house a second seat therein;
a first seat devised to secure into the first seat pocket, said first seat configured to house at least a portion of the tap clamp bolt head therein; and
a second seat devised to secure into the second seat pocket, said second seat configured to house at least the remaining portion of the tap clamp bolt head therein;
wherein the handwheel member is securable to the tap clamp bolt when the tap clamp bolt head is encased in the first and second seats and the first portion is secured to the second portion.

14. The tap clamp handwheel drive of claim 13 further comprising a hot stick loop securely couplable thereto.

15. The tap clamp handwheel drive of claim 14 wherein the hot stick loop is connectable between the first and second portions.

16. The tap clamp handwheel drive of claim 15 wherein the tap clamp bolt head is a hot stick loop.
